(19) United States
(12) Patent Application Publication
(10) Pub. No.: US 2010/0195174 A1
(43) Pub. Date: Aug. 5, 2010

(54) Data Storage in a Diffractive Optical Element

(75) Inventors: Joshua Robert Nemeth, Victoria (AU); Gary Fairless Power, Victoria (AU); Robert Stewart, Cumbria (GB)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: SECURENCY INTERNATIONAL PTY. LTD., Craigieburn, Victoria (AU)

(21) Appl. No.: 12/161,036

(22) PCT Filed: Jan. 16, 2007
(86) PCT No.: PCT/AU2007/000038

§ 371 Date: Mar. 11, 2010

(30) Foreign Application Priority Data
Jan. 16, 2006 (AU) 2006900204

(51) Int. Cl. G03H 1/00

(52) U.S. Cl. 359/2

(57) ABSTRACT

A diffractive optical element (DOE) and various methods of producing such a DOE are provided in which a diffractive optical microstructure is formed with encrypted data on at least one side of a transparent substrate or in a layer applied to the substrate. The diffractive optical microstructure when illuminated with collimated light, generates a far field interference pattern corresponding to the encrypted data which may be decrypted with suitable optical detectors and processing equipment.

### FIELD OF THE INVENTION

This invention relates to data storage and is particularly, but not exclusively, concerned with data storage in security documents.

### BACKGROUND OF THE INVENTION

In security documents such as passports and identification cards it is often required to store personal data securely on the document. There currently exist several data storage mechanisms which have been used in security documents, including: barcodes, magnetic stripes, optical CD technology contact IC chips and contactless IC chips. Each of these data storage devices have some inherent advantages and disadvantages, but most of them suffer from the disadvantage that whilst they have the ability to store high volumes of information, the cost of producing security documents incorporating such data storage devices is generally very high.

It is therefore desirable to provide a relatively low cost data storage device suitable for incorporation into security documents and other articles.

It is also desirable to provide a convenient and relatively inexpensive method of producing a security document with a data storage device.

### SUMMARY OF THE INVENTION

According to a first aspect of the invention there is provided a diffractive optical element (DOE) comprising a diffractive microstructure which includes encrypted data physically stored within the microstructure, wherein when the DOE is illuminated with substantially collimated light, the diffractive microstructure generates a far field interference pattern corresponding to the stored data that is reconstructed in a reconstruction plane remote from the DOE.

Before the present invention, diffractive optical microstructures, otherwise known as diffractive optical elements (DOEs), have been used as authentication devices in security documents such as banknotes. Such a diffractive optical element, when illuminated with substantially collimated light, generates an interference pattern which produces a projected visual image when reconstructed in the reconstruction plane. However, the use of such DOEs in security documents for storage of encrypted data other than for producing projected visual images has hitherto not been previously proposed.

According to another aspect of the invention, there is provided a security document or article which includes a diffractive optical element (DOE) in accordance with the first aspect of the invention.

The present invention is particularly applicable to diffractive microstructures known as numerical-type diffractive optical elements (DOEs). The simplest numerical-type DOEs rely on the mapping of complex data that reconstruct in the far field (or reconstruction plane) a two-dimensional intensity pattern. Thus when substantially collimated light, eg from a point light source or a laser, is incident upon the DOE, an interference pattern is generated that corresponds to the stored data and which may be detected by suitable apparatus located in the reconstruction plane remote from the DOE. The transformation between the two planes can be approximated by a fast Fourier transform (FFT). Thus, complex data including amplitude and phase information has to be physically encoded in the microstructure of the DOE. This DOE data can be calculated by performing an inverse FFT transformation of the desired reconstruction (ie the desired intensity pattern in the far field).

In one preferred embodiment the security document or article incorporating the DOE is an identification document, and the stored encrypted data in the microstructure of the DOE includes personalised data relating to the holder of the identification document. For example, the identification document could be a passport, identity card or credit card containing the name and identity number or account number of the holder on the document outside the area where the DOE is provided, with the stored encrypted data in the DOE also containing the name and identity or account number of the holder. Thus, the personalised encrypted data in the DOE provides an additional check for verifying the authenticity of the document and deters an unauthorised person from tampering with the identification document by altering the name or number printed on the card.

The encrypted data may be readable by apparatus including a detector located in the reconstruction plane and decryption means for decrypting the encrypted data detected by the detector.

The data stored in the DOE may be digitally encoded data or analogue encoded data. It is possible to encode analogue data in a DOE by using blaze angle gratings. This has the advantage of being more difficult for an unauthorised person to replicate, but can be more prone to noise when reading the encoded data.

In one embodiment, the DOE may also be arranged to generate a projected visual image in the reconstruction plane when the DOE is illuminated with substantially collimated light. For instance, the projected visual image may be an image of the holder of the identification document. The projected visual image may be generated by a first set of pixels or vector elements in the DOE and the encrypted data may be stored in a second set of pixels or vector elements, preferably intertwined with the first set for extra security.

In a particularly preferred embodiment, the diffractive optical microstructure comprises a plurality of apertures formed in a substantially opaque layer disposed on the substrate.

According to another aspect of the invention, there is provided a method of storing and reading data in a document including the steps of:

providing a diffractive optical microstructure in the document wherein encrypted data is stored in the microstructure;

illuminating the diffractive optical microstructure with substantially collimated light whereby a far field interference pattern is generated corresponding to the encrypted data that is reconstructed in a reconstruction plane remote from the diffractive optical microstructure;

detecting the far field interference pattern in the reconstruction plane; and

decrypting the encrypted data detected in the interference plane.

The far field interference pattern generated by the diffractive optical microstructure is preferably detected by detecting the light intensity of the interference pattern in the reconstruction plane. The encrypted data in the light intensity pattern may then be decrypted by a computer program which transforms the detected light intensity pattern into machine readable data.

According to a further aspect of the invention, there is provided apparatus for reading encrypted data stored in a diffractive optical microstructure in a document including:

means for directing a substantially collimated beam of light onto the diffractive optical microstructure such that the beam is transformed into a far field interference pattern corresponding to the stored encrypted data that is reconstructed in a reconstruction plane remote from the microstructure;

optical detection means located in the reconstruction plane for detecting the far field interference pattern and for generating signals representing the stored encrypted data; and

processing means for receiving and processing the signals from the optical detection means, wherein the processing means includes decryption means for decrypting the encrypted data represented by the signals from the detection means.

In various embodiments of the invention, a variety of different approaches may be taken for forming the diffractive optical microstructure on the substrate or in a layer applied thereto. In one general class of processes according to embodiments of the invention, a layer is applied to the substrate, and the diffractive optical microstructure is formed by a plurality of apertures in this layer eg by ablation. Additional layers may be applied to the substrate either before or after ablation, ie the diffractive optical microstructure may be formed in a surface layer, or in an internal layer of a plurality of layers applied to the substrate.

In some embodiments of the invention, the layer applied to the substrate is an opacifying layer, whereby a transmissive diffractive optical microstructure is formed by ablation of apertures in the opacifying layer.

In another general class of processes according to embodiments of the invention, the diffractive optical microstructure is formed by ablation of the surface of the substrate itself. Following ablation, the surface may be coated with a reflective film, to produce a diffractive optical structure that is visible in reflection through the transparent substrate. Alternatively, the surface may be left uncoated, or be coated with a transparent coating having a different refractive index to that of the substrate. According to this method, a diffractive optical element can be formed that is visible in transmission through the document, when illuminated using a point light source, such as a visible laser, projected onto a suitable viewing surface.

Furthermore, in accordance with embodiments of the invention various means and methods may be employed to ablate a layer applied to the substrate, or to ablate the surface of the substrate itself.

One general ablation process applicable to embodiments of the invention is laser ablation, involving the exposure of one or more areas of the substrate, or layer applied thereto, to laser radiation in order to form a three dimensional optically diffractive structure therein, or to ablate apertures in an opaque layer.

According to preferred embodiments, laser ablation may be performed by direct laser scanning of the desired personalised diffractive optical microstructure onto the surface of the substrate or layer applied thereto. Advantageously, direct laser scanning includes the individualised control of a laser beam, such as by the use of computer numerical control (CNC), in order to form an individual or unique optical microstructure.

Alternatively, laser ablation may be performed by first forming a personalised mask corresponding with the desired personalised diffractive optical microstructure using appropriate methods in accordance with embodiments of the invention, and then exposing the substrate, or layer applied thereto, to laser radiation directed through the mask. The mask may be designed such that the substrate or layer is exposed in the near field to laser radiation directed through the mask, whereby the mask includes apertures substantially formed in the shape of the desired areas to be ablated. Alternatively, the mask may be designed such that the substrate or layer is exposed in the far field to laser radiation directed through the mask, whereby the mask includes apertures formed to produce a diffraction pattern corresponding with the shape of the desired areas to be ablated.

Advantageously, the mask may be manufactured to a larger scale than the desired diffractive optical microstructure, which is subsequently created by exposure of the substrate or layer applied thereto by reducing optics, such as a suitable lens arrangement. Advantageously, this approach increases the required minimum feature size of the mask, thereby enabling the use of lower precision equipment for the formation of the mask. Furthermore, the mask may be generated in cheap materials, such as aluminium coated polypropylene. In addition, the durability of the mask may be improved due to the reduced required optical power density instant upon the mask. All of the aforementioned factors may reduce the cost and complexity of mask production, thereby enabling individually personalised masks to be produced for use in forming corresponding personalised diffractive optical microstructures within acceptable timeframes and at acceptable costs.

In this regard, masks may generally be made by a variety of methods, including, but not limited to, the various techniques disclosed herein for forming optical structures in opaque layers disposed on the surface of transparent substrates.

In particularly preferred embodiments, the method involves generating a mask in parallel with the manufacture of other features and elements of the security document or article, thereby further reducing the overall time required to manufacture the final security document or article.

According to one preferred method in accordance with the invention, the desired diffractive optical microstructure is represented as an array of discrete elements. In a particularly preferred embodiment, the diffractive optical microstructure is represented as a two dimensional field having predetermined dimensions, and the method includes:

subdividing the two dimensional field into an array of discrete elements; and

determining the content of discrete elements of the field in order to form the stored data of the diffractive optical microstructure.

Each discrete element may be a square or rectangular pixel, and accordingly the data may be stored in the diffractive optical microstructure as a bitmap. The resulting bitmap may be used for direct laser scanning of the substrate, for example using an XY galvanometer or a CNC stage to scan a laser over the substrate whereby the laser is activated to ablate points on the substrate or layer applied thereto corresponding with discrete elements or pixels of the bitmap. The laser used for this process may be, for example, a frequency tripled or quadrupled Nd:YAG system with a telecentric scanning head, providing a pixel size of typically 7 microns. Alternatively, a CNC stage may be used in conjunction with a frequency doubled Nd:YAG laser, providing typically a smaller pixel size of 5 microns or less.

In other embodiments, instead of representing the diffractive optical microstructure as an array of discrete elements, the microstructure may be represented as a plurality of narrow vector elements or tracks. According to methods of this type, each track is sufficiently narrow to cause diffraction of light passing therethrough. The tracks may be straight, curved or of arbitrary shape in accordance with the requirements of the desired diffractive optical microstructure. The method may then include:

generating a diffractive optical microstructure mask image; and

converting the diffractive optical microstructure mask image into a plurality of vectors corresponding with the narrow tracks. This conversion to form a representation of the diffractive optical microstructure as a plurality of narrow tracks may be performed digitally upon a bitmap image of the diffractive optical microstructure mask using image analysis techniques known in the art.

A particular advantage of embodiments based upon a diffractive optical microstructure represented as a plurality of narrow tracks is that a laser having a relatively large spot size may be used to generate the corresponding mask. For example, track widths of 20 to 25 microns may be used to produce diffractive optical microstructures substantially equivalent to those produced from bitmap images having a pixel size of around 10 microns. As with previously described embodiments, direct laser scanning using an XY galvanometer or a CNC stage may be used to generate a suitable mask from the representation based upon a plurality of narrow tracks.

In still further embodiments, the diffractive optical microstructure may be represented as a tiled array of square or rectangular sub-regions, each corresponding with, for example, a group of pixels. In preferred embodiments, each sub-region may correspond with an area of around 10 to 20 pixels wide by 10 to 20 pixels high. Preferably, each sub-region is approximated by one of a predetermined plurality of masks, each mask defining a fixed graphical form, for example, a curve, a vertical line, a horizontal line, and/or a line arranged along a diagonal or at any arbitrary angle relative to the sub region.

A desired personalised diffractive optical microstructure, or a mask for forming such a diffractive optical microstructure, may then be constructed by exposing the sub-regions of the substrate or layer applied thereto to laser radiation through corresponding masks selected from the predetermined plurality of masks.

In a representative embodiment, a library of around 100 masks or fewer may be provided representing various possible configurations of each square or rectangular sub-region of the tiled array representing the diffractive optical microstructure. In a particularly convenient arrangement, the library of masks may be formed on a single plate, such as a quartz mask plate, positionable to expose the corresponding sub-regions of the representation in accordance with the desired diffractive optical microstructure. Advantageously, embodiments of the invention based upon representing the diffractive optical microstructure as a tiled array of sub-regions may result in a considerable reduction in the formation time of the microstructure, by comparison with individual pixel writing methods. For example, a 4 to 16 million pixel mask may be reduced to only 20,000 sub regions which, at 200 Hz, may be formed in around 100 seconds.

In yet further embodiments, a personalised diffractive optical microstructure may be formed by direct imaging including the step of directing a laser beam onto the substrate, or layer applied thereto, using a micro-mirror array. Such an array may consist of a very large number, for example millions, of individual micro-mirrors, each of which may be controlled electronically in order to direct the reflective face of the mirror at a desired angle. In preferred embodiments, the angle of each mirror is set either to direct light onto, or away from, the substrate or layer, in order to generate a pattern of illumination corresponding with the diffractive optical microstructure to be formed thereon.

In one advantageous arrangement, the light directed away from the substrate by the mirrors may be directed at a second target, such as a further similar substrate, in order to generate a second identical diffractive optical microstructure on the second target using the same laser pulse. As will be appreciated by those skilled in the art, the inverse of a mask for forming a diffractive optical microstructure produces a structure having identical optical imaging properties to the original, uninverted, mask.

In variations of this method, multiple smaller beams may be used in combination with smaller and simpler micro mirror arrays in order to generate a diffractive optical microstructure using patterns of interference between said beams.

Yet another alternative method of producing a personalised diffractive optical microstructure includes providing at least two masks, each of which may again be selected from a library of masks, each thereby corresponding with a predetermined diffractive element. The step of forming the diffractive optical microstructure on the substrate or layer applied thereto may then include exposing the substrate or layer to laser radiation directed through each one of said masks. In accordance with this method, a diffractive optical microstructure is produced which is a superposition of the diffractive elements corresponding with the masks. When suitably illuminated, such as with a substantially collimated beam of light, an image is generated which includes sub-images corresponding with each of the constituent diffractive elements. Accordingly, personalised diffractive optical microstructures may be formed from unique combinations of selected masks, or from combinations of masks that are specific to a particular individual. For example, a library of masks corresponding with generated images of alphanumeric characters may be provided, and diffractive optical microstructures formed from superimposed combinations of two such masks, corresponding with the initials of a particular individual. The superposition of diffractive elements may be performed, in various embodiments, either by simultaneous or sequential exposure of the substrate, or layer applied thereto, to laser radiation directed through the masks.

In still further embodiments of the invention, methods other than direct laser writing may be used to form diffractive optical microstructures containing stored data and/or to form masks suitable for the creation of diffractive optical microstructures by laser writing methods.

For example, according to one such embodiment a diffractive optical microstructure or a mask may be formed by printing the required pattern onto a suitable transparent substrate. Preferably, a printing technique is employed that is capable of providing a true resolution of 5,000 dpi, thereby producing printed pixels on the mask having dimensions of around 5 microns. It will be appreciated that the term “true resolution” is intended to refer to the actual pixel size, and not to the density of ink spots printed, to which the specification of printing resolution often relates. That is, printing techniques compatible with embodiments of the invention must deposit toner or ink elements of a sufficiently smaller size for the formation of a diffractive optical microstructure mask, and not merely provide printed elements of a high density.

In further embodiments of the invention, a direct mechanical process may be used to form a diffractive optical microstructure and/or a mask for the production of a diffractive optical microstructure. According to some embodiments of this type, a CNC stage may be fitted with one or more mechanical ablating structures, such as needles, which may be used to selectively physically remove layers of coating from a substrate, such as by scraping. Layers may be mechanically removed in this manner from the substrate itself, or from a photoresist or other layer disposed on the surface of the substrate for this purpose. According to preferred embodiments, a diffractive optical microstructure of a corresponding mask is thereby formed through the operation of an XY scanning system controlling the needles in order to mechanically ablate individual elements or pixels, or alternatively to ablate narrow tracks or vectors.

Yet further embodiments of the invention may employ electro-chemical machining for the formation of diffractive optical microstructures and/or masks for use in the production of diffractive optical microstructures. According to a method of electro-chemical machining, portions of a metal layer are removed from a substrate using an electrical current in a suitable salt solution. An electrode is preferably provided which is shaped to correspond with the areas of the metal layer that are to be removed from the substrate. According to one embodiment, a reconfigurable electrode is formed as an array of individual electrode elements, such as pins, selectably extensible or retractable to generate a desired diffractive optical microstructure pattern, in the manner of an array of pixels. Such an electrode may be used to form a desired pattern, and to image the pattern onto metalised quartz or polymer, whereby the resulting mask may be used for the formation of a diffractive optical microstructure using laser writing techniques.

As will be appreciated from the foregoing summary, methods in accordance with the present invention provide practical time and cost effective processes for the formation of diffractive optical microstructures containing stored date on security documents and/or other articles. In accordance with the invention, limitations of the prior art whereby it is generally practical only to mass produce predetermined diffractive optical micro structures are mitigated, thereby enabling the practical realisation of unique, secure documents with stored data.

In one preferred method, the stored data may be encrypted before the diffractive optical microstructure is created. Alternatively, the data may be encrypted during a Fourier transform calculation for the creation of the diffractive optical microstructure.

Another preferred method may include the step of storing a visual image in the diffractive optical microstructure such that when suitably illuminated a projected visual image, such as a personalised image, is generated which is viewable in the reconstruction plane. Parts of the diffractive optical microstructure representing the encrypted data may be intertwined with parts of the microstructure representing the visual image for extra security.

In another aspect, the present invention provides a personalised security document or article which includes:

a substrate which is transparent at least to visible light; and

a diffractive optical microstructure formed on the substrate or in a layer applied thereto, using any one of the method's hereinbefore described.

### BRIEF DESCRIPTION OF THE DRAWINGS

Preferred embodiments of the present invention will now be described, by way of example only, with reference to the accompanying drawings, in which:

FIG. 1 is a plan view of an identification card incorporating a diffractive optical element in accordance with an embodiment of the invention;

FIG. 2 is a schematic view on the line II-II of FIG. 1;

FIG. 3 is an enlarged schematic view of the diffractive optical element of FIG. 1;

FIG. 4 is a schematic view of apparatus for detecting data stored in a diffractive optical element in a document.

FIG. 5 is a schematic view of apparatus for detecting data stored in a diffractive optical element in a modified document;

FIG. 6 is a block diagram of apparatus for reading encrypted data stored in a diffractive optical element;

FIG. 7 is a schematic view illustrating a method of producing a diffractive optical element with stored data in accordance with an embodiment of the invention;

FIG. 8 is a schematic view of another method of producing a diffractive optical element with stored data;

FIG. 9 is a schematic view of a further method of producing a diffractive optical element with stored data;

FIG. 10 is a schematic section through an identification card incorporating a diffractive optical element with stored data;

FIG. 11 illustrates an apparatus for performing a method of direct laser scanning using an XY galvanometer according to an embodiment of the invention;

FIG. 12 illustrates an apparatus for performing a method of direct laser scanning using a CNC stage according to an embodiment of the invention;

FIG. 13 illustrates an example of pixel marking of a substrate according to an embodiment of the invention;

FIG. 14 illustrates an example of vector scanning of a substrate according to an embodiment of the invention;

FIG. 15 illustrates an example of sub-region masks for a method of scanning mask ablation according to an embodiment of the invention.

FIG. 16 illustrates apparatus for performing a method of scanning mask ablation according to an embodiment of the invention;

FIG. 17 illustrates apparatus for performing a method of direct imaging using a micro-mirror array according to an embodiment of the invention;

FIG. 18 illustrates apparatus for performing a method of direct CNC machining according to an embodiment of the invention; and

FIG. 19 illustrates apparatus for performing a method of electro-chemical machining according to an embodiment of the invention.

### DETAILED DESCRIPTION OF PREFERRED EMBODIMENTS

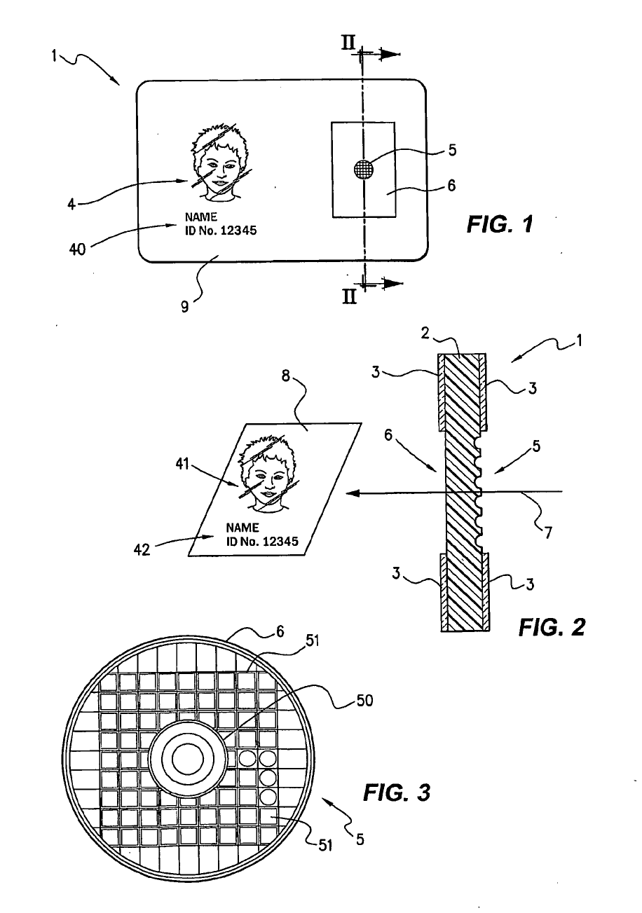

Referring to FIGS. 1 and 2 there is shown a security document in the form of an identification card 1 incorporating a personalised diffractive optical element 5 in accordance with the invention. The identification card 1 is formed from a transparent substrate 2 of polymeric material such as a laminate including at least one layer of biaxially oriented polypropylene. One or more opacifying layers 3 are applied to opposite surfaces of the substrate 2 in such a manner as to form a transparent window 6 in an area of the substrate 2 which is uncovered by the opacifying layers 3. The personalised diffractive optical element 5 is provided in the transparent window 6.

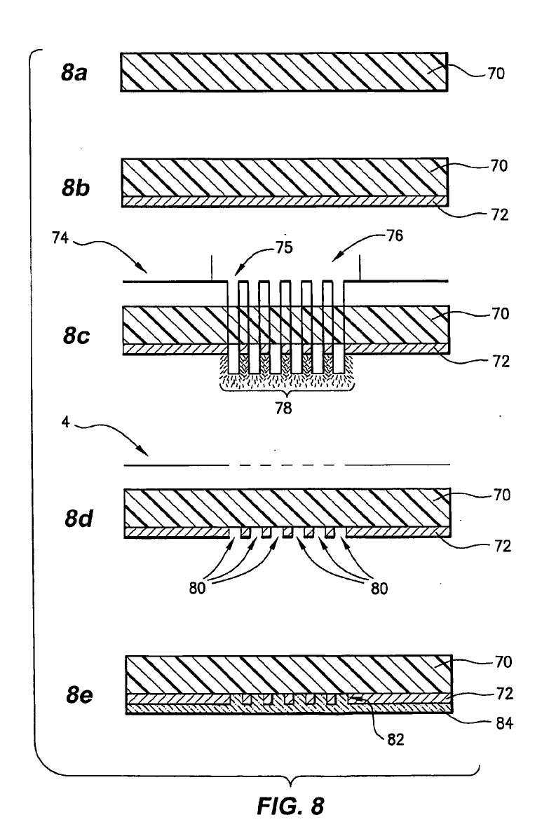

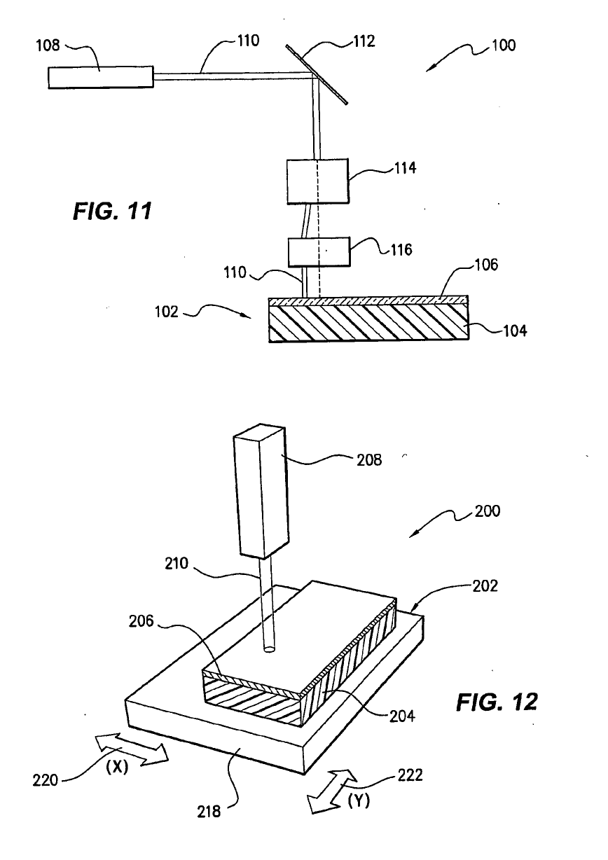

While the identification card 1 illustrated in FIGS. 1 and 2 incorporates a transmissive diffractive optical element formed by ablation of a surface of substrate 2, this embodiment is provided by way of example only, and a variety of methods and structures may be employed for providing a diffractive optical element within a security document or other article. For example, a transmissive or reflective diffractive optical element may be provided by the application and/or ablation of additional transparent or reflective layers to the substrate, such as described hereafter with reference to FIG. 7. Alternatively, a transmissive diffractive optical element may be provided by ablating apertures in an opaque layer applied to the substrate, such as described hereafter with reference to FIGS. 8 to 10. Various methods suitable for forming these and other diffractive structures are described herein, by way of example, with reference to FIGS. 11 to 19.

In one embodiment, the opacifying layers 3 may be formed from a pigmented coating containing titanium dioxide, and information 40, such as the card number, the name of the card holder may be printed and/or embossed on the opacifying layers. As shown in FIG. 1 a photograph 4 of the card holder is also provided on the opacified portion 9 of the card 1.

As shown in FIG. 2, the personalised diffractive optical element 5 is a diffractive microstructure in the form of a numerical-type diffractive optical element (DOE) which when illuminated by a beam of substantially collimated light 7, eg from a point light source or laser, generates an interference pattern that produces a projected image 41 in a reconstruction plane that is visible when a viewing surface, such as a screen 8 is located in the reconstruction plane. The projected image 41 shown in FIG. 2 includes an image of the card holder corresponding to the photograph 4 of the card holder on the opacified portion of the card 1. Thus, in the event of tampering with the card to remove, alter or replace the photograph 4 of the card holder, it is possible to detect that the card has been tampered with by comparing the projected image 41 with the photograph 4 on the card itself.

In accordance with embodiments of the invention, the DOE 5 also includes data stored within its diffractive microstructure. The data may include alphanumeric data, such as the personal details of the card holder, eg the card holders name and identification or account number 42 which may be viewed on the viewing screen B in the reconstruction plane as illustrated in FIG. 2. Additionally, the data stored in the microstructure of the DOE 5 includes encrypted information which requires appropriate decryption apparatus for reading the encrypted data.

Referring to the schematic enlarged view of the DOE 5 in FIG. 3, the DOE 5 has a central diffractive zone 50 and an array of smaller diffractive pixel elements 51 each of which can store individual bits of information. In conventional DOEs, the central diffractive zone 50 and the pixel elements 51 correspond to different parts of the projected image 41 produced on viewing screen B in the reconstruction plane by the interference pattern generated when the DOE 5 is illuminated with substantially collimated light. A typical DOE for producing projected visual images may be located within a 75×75 μm (micron) square and can contain up to 3025 (55×55) pixels.

In contrast to conventional DOEs for producing projected visual images, at least some of the pixels 51 of the DOE are used to store encrypted data, and may additionally include further data other than visual images, such as alphanumeric data. It will be appreciated that if the size of the DOE is increased, eg to a 30 mm×30 mm square, the number of pixels is greatly increased. For example, in a 30 mm×30 mm square DOE, it is possible to store about 57 Mb of information, without redundancy.

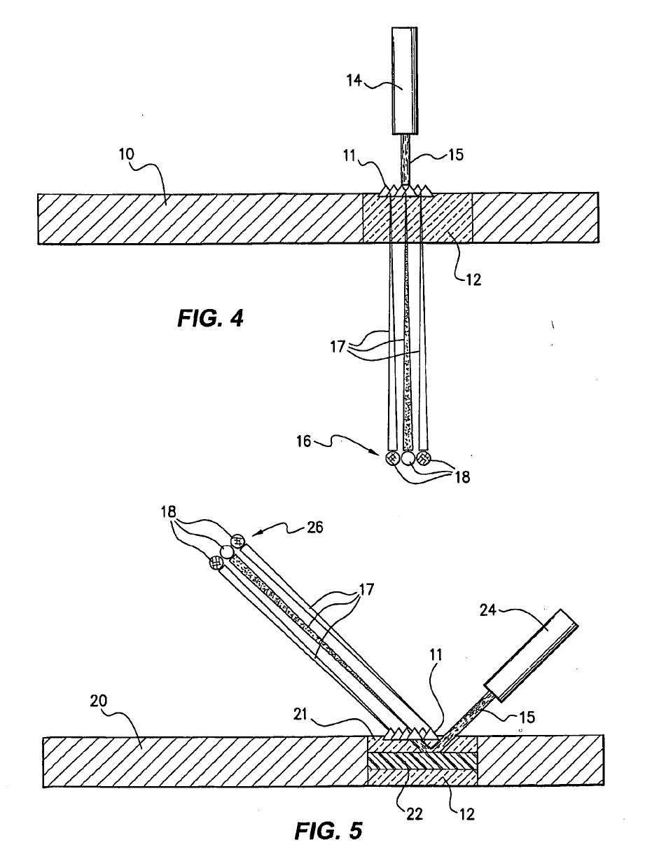

When the data stored in the DOE is encrypted, apparatus for reading the encrypted data is required, as illustrated schematically with reference to FIGS. 4 to 6.

FIG. 4 shows apparatus for reading encrypted data from document 10 incorporating a diffractive optical element (DOE) 11 provided in a transparent portion or window 12 of the document 10. The apparatus comprises a point light source 14 which directs an incident beam of substantially collimated light 15 onto the DOE 11, and detection means in the form of an optical detection device 16.

In one preferred embodiment, the document 10 may be formed from an at least partially transparent substrate having one or more opacifying layers or coatings applied to at least one face of the substrate. The transparent portion or window 12 of the document 10 may be formed by applying the opacifying layers or coatings to the substrate in such a manner that the substrate 12 is substantially free of opacifying layers or coatings in the region of the transparent portion or window 12. The transparent substrate may be formed from a transparent polymeric material, such as polyethylene (PE), polypropylene (PP) or polyethylene terephthalate (PET). In the case of security document such as a banknote, the substrate is preferably formed from at least one biaxially oriented polymeric film. The substrate may comprise a single film of polymeric material. Alternatively, the substrate may comprise a laminate of two or more layers of transparent biaxially oriented polymeric film.

It will, however, be appreciated that the present invention is equally applicable to documents formed from paper or other partially or fully opaque material, In this case, an aperture may be formed in the paper or other material and a patch of transparent polymeric material inserted into or applied over the aperture to form the transparent portion or window 12.

The opacifying layers may comprise one or more of a variety of opacifying inks which can be used in the printing of banknotes or other security documents. For example, the layers of opacifying ink may comprise pigmented coatings comprising a pigment, such as titanium dioxide, dispersed within a binder or carrier of cross-linkable polymeric material.

The diffractive optical element (DOE) 11 acts to transform the incident light beam 15 from the point light source 14 as the beam passes through the at least partially transparent portion 12 of the security document (the window created through the security document) into an interference pattern 17. The DOE 11 is a complicated surface micro relief structure which includes encrypted data stored in its pixels. Whilst the optical transformation of the incident light beam 15 to the interference pattern 17 is based on the optical principle of diffraction, the mathematics of the structure of such devices is specifically designed in each case to produce a distinct optical transformation so that the encrypted data is detected by the optical detector 16 is in a reconstruction plane located at a particular point in space away from the document 10. The location of the optical detector 16 can be dependent on the wavelength of the light beam used.

The point light source 14 for producing the incident beam 15 may comprise an LED, a halogen light source, a laser or other light source for producing a beam of substantially collimated light which is directed on the DOE 11.

The optical detection device 16 is position at the particular reconstruction plane in space at which the interference pattern 17 containing the stored data is reconstructed by the DOE 11.

The presence of the encrypted data stored and projected by the DOE 11 is determined by the amplitude of the response of the detector 16 at particular points in space where the detector is located. For this purpose, the detector may comprise an array of photo-diodes 18, or a charge couple device (CCD) such as a line CCD or a matrix CCD.

FIG. 5 shows a modified embodiment which is similar to FIG. 4 and corresponding reference numerals have been applied to corresponding parts. The document 20 in FIG. 5 differs from that of FIG. 4 in that the transparent portion or window 12 incorporates a reflective surface 21 underneath the diffractive optical projection element (DOE) 11. The reflective surface may be provided by a metallic layer 22 provided within the window 12 or by a metallised coating applied to a surface of the transparent portion forming the window 12 before the DOE 11 is applied over the reflective surface 21.

The apparatus of FIG. 5 also differs from that of FIG. 4 insofar as the point light source 24 and the optical detector 26 are located on the same side of the document 20. The light source 24 is arranged to direct a substantially collimated incident beam 15 onto the window 12 at an acute angle to the perpendicular to the surface of the security document 20 so that the incident beam 15 is reflected back from the reflective surface 21 of the metallic layer 22 onto the DOE 11. The reflected beam passes through the DOE 11 and is transformed by the DOE 11 into an interference pattern 17 in similar manner to the embodiment of FIG. 1.

The detector 26, which may also comprise an array of photo-diodes 18 or a line or matrix CCD, is disposed at a position relative to the security document 20 to receive the patterned beam 17 which also travels from the DOE 11 at an acute angle to the perpendicular to the surface of the security document 20 corresponding to the angle of the incident beam 16. Otherwise, the detector 26 functions in exactly the same manner as the detector of FIG. 1 by determining the amplitude of different parts of the reconstructed projected data formed by the interference pattern 17 at particular points in space in the reconstruction plane where the photo-diodes 18 are located.

In an alternative embodiment similar to FIG. 2, the light source 24 is arranged to direct the substantially collimated incident beam at an acute angle onto the DOE 11 which transforms the beam into an interference pattern 17 that is reflected by the reflective surface 22 and projected onto the detector 26 located in the reconstruction plane at the particular position in space where the data is reconstructed by the interference pattern 17. It is also possible that the DOE could be viewed in reflection without an underlying metallic surface using the reflectivity of the polymer surface.

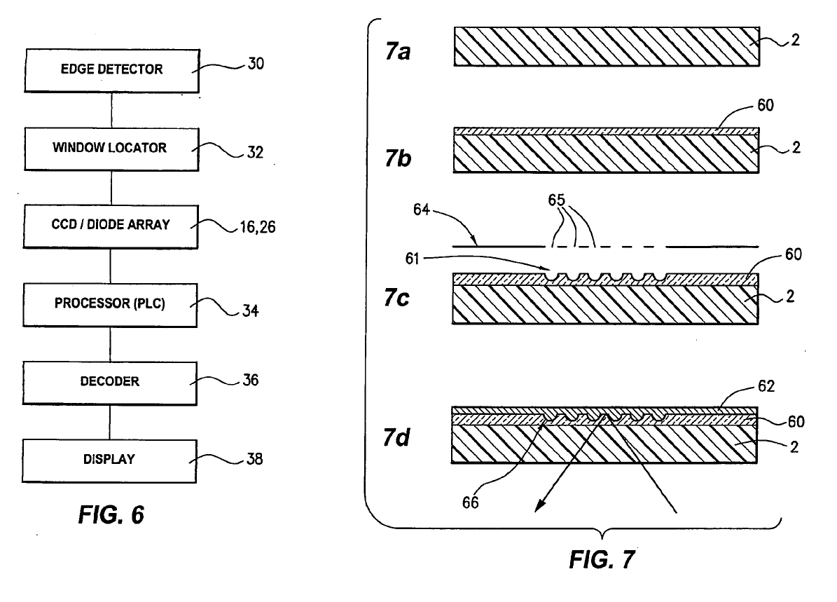

FIG. 6 illustrates a processing apparatus and method of reading encrypted data utilizing the detection apparatus of FIG. 1 or FIG. 2.

The equipment of FIG. 6 comprises an edge detector 30 for detecting the presence of a security document, such as an identification card, a window locator 32 for locating a window 12 in a security document incorporating a DOE 11, an optical detector 16, 26 in the form of a CCD or photo-diode array for detecting an interference pattern 17 generated by the DOE 11, a processor 34 for processing and analysing signals from the optical detector 16, a decoder for decrypting encrypted data signals from the processor, 34, and a visual display 38 for displaying the data decrypted by the decoder 36.

A preferred method of operation of the apparatus of FIGS. 4 to 6 will now be described. When a security document 10, 20 such as an identification card, enters the apparatus the edge detector 30 detects the presence of the document to activate the window locator 32. When the window locator 32 locates a window 12 in the document 10, 20, the light source 14, 24 and the CCD or photodiodes array 18 of the optical detector 16, 26 are activated, eg by means of a time-gated output from the processor 34.

The optical detector 16, 26 then detects the light intensity of the interference pattern 17 generated by the diffractive optical element (DOE) 11 at the reconstruction plane where the CCD or diode array 18 is located and produces output signals corresponding to the encrypted light intensity data stored in the DOE 11. These signals representing the encrypted data are input to the processor 34 which analyses the signals. The processor 34 may comprise a process logic chip (PLC) or a microprocessor, such as a PLC chip which transforms the signals into machine readable data signals. The signals transformed by the processor 34 are decrypted by decoder 36 and then the decrypted information can be displayed on the VDU 38.

A diffractive optical element (DOE) including stored data in the form of alphanumeric and/or encrypted data may be made by a variety of methods, some of which are described with reference to FIGS. 7 to 15.

Referring to FIG. 7, there is provided a substrate 2 of transparent polymeric material (FIG. 7a) to which a transparent coating 60 is applied (FIG. 7b). A mask 64 containing apertures 65 corresponding to the diffractive optical microstructure for the DOE is placed in front of the substrate 2 and the transparent coating 60 is irradiated with laser radiation through the mask 65 to form the diffractive optical microstructure 61 of the DOE by laser ablation of the transparent coating 60 as illustrated by FIG. 7c.

The diffractive optical microstructure of the DOE formed in the transparent coating 60 applied to the substrate 2 may be used as a transmissive DOE continuing alphanumeric and/or encrypted data in similar manner to that illustrated by FIGS. 2 and 4. In a modified embodiment (not shown), the diffractive optical microstructure 5 may be formed by laser ablation directly in the surface of the substrate 2 of transparent polymeric material as shown in FIG. 2.

In another embodiment shown in FIG. 7d, a reflective coating 62, eg of metallic material, may be applied over the transparent coating 60 to form a reflective DOE 66 containing alphanumeric or encrypted data which may be used in similar manner to that of FIG. 5.

An alternative method of producing an article, such as an identification card, with a DOE containing stored alphanumeric and/or encrypted data is illustrated by FIG. 8.

In FIG. 8, there is shown a transparent plastics film 70 formed from polymeric material, used in the manufacture of a security document, or similar article, such as an identity card. The substrate 70 may be made from at least one biaxially oriented polymeric film. The substrate 70 may include or consist of a single layer of film of polymeric material, or, alternatively, a laminate of two or more layers of transparent biaxially oriented polymeric film. The substrate 70 is shown in cross section in FIG. 8a.

An opacifying layer 72 is applied to one surface of substrate 70 (FIG. 8b). The opacifying layer 72 may include any one or more of a variety of opacifying inks suitable for use in the printing of security documents formed from polymeric materials. For example, the layer of opacifying ink 72 may include pigmented coatings having a pigment, such as titanium dioxide, disbursed within a binder or carrier of heat activated cross-linkable polymeric material.

Laser radiation, in the form of laser beam 76, is then directed onto a mask 74 that is interposed in the path of the laser radiation (FIG. 8c). Mask 74 has apertures, eg 75, through which the laser radiation passes. The passing of the laser radiation through the apertures of the mask 74 results in the formation of a patterned laser beam 78 which bears a pattern corresponding with the desired diffractive structure in accordance with the mask 74.

In accordance with the embodiment illustrated in FIG. 8, the patterned laser beam 78 passes through transparent substrate 70 and irradiates opacifying layer 72. The wavelength of the laser radiation, and the polymeric material used to form substrate 70, are selected such that the substrate 70 is substantially transparent to the laser radiation. Accordingly, the patterned laser beam 78 is able to pass through substrate 70 with little or no absorption of the radiation, and therefore little or no heat build up and subsequent damage to the substrate, to impinge upon opacifying layer 72. In the preferred embodiment, the substrate is formed of biaxially oriented polypropylene (BOPP) and the wavelength of the laser radiation used is approximately 248 nm, derived from an excimer laser source.

The opacifying layer 72 is a relatively strong absorber of laser radiation at the selected wavelength, and therefore the patterned laser radiation is absorbed in opacifying layer 72, resulting in particles of opacifying layer 72 being ablated in accordance with the pattern of laser beam to form apertures 80 in the opacifying layer (FIG. 8d).

The apertures 80 form the optically diffractive microstructure of the DOE 82. Visible light emitted from a point source on one side of opacifying layer 70 will pass through apertures 80, but be blocked by the remaining, unablated opacifying ink layer 72. A diffraction pattern containing alphanumeric and/or encrypted data will thus be formed in the transmitted light, which is reconstructed in a reconstruction plane remote from the DOE. The data stored is determined by the pattern of ablated portions 110, which is in turn determined by the pattern of apertures in mask 104. Accordingly, by forming an appropriate mask, a diffractive structure 112 may be created corresponding to any desired data.

Subsequent to forming the diffractive optical structure 82, a further protective layer 84 may be applied over the structure (FIG. 8e). The protective layer may be, for example, a protective varnish coating, or a further transparent laminate. The protective layer 84 will fill the ablated regions 80 in the opacifying layer 72, however since the diffractive optical structure 82 relies upon transmission of light through the ablated portions rather than on a change in refractive index, such filling of the ablated regions does not result in the destruction of the diffractive microstructure.

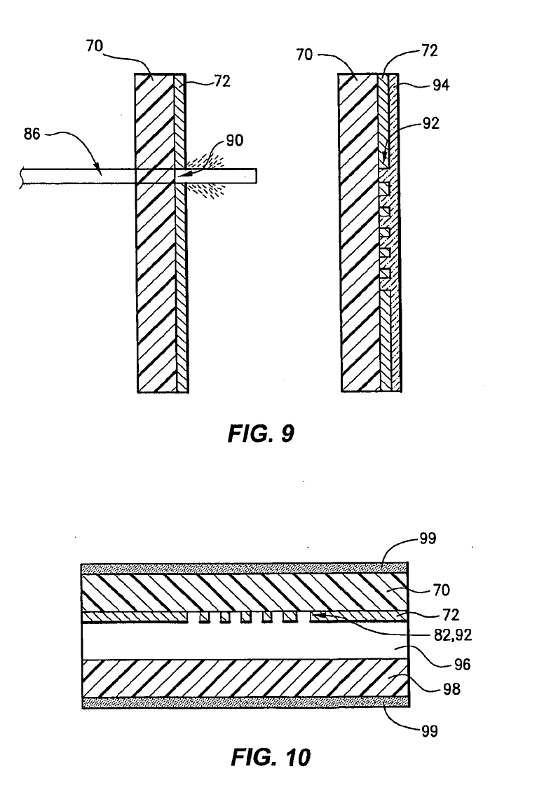

Turning now to FIG. 9, there is shown an alternative embodiment of the invention, in which a transparent plastics substrate 70 formed from polymeric material has been coated with opacifying layer 72. Focussed or collimated laser beam 86 is directed onto opacifying layer through transparent substrate 70. By the same processes previously described with reference to FIG. 8, laser beam 86 passes through transparent substrate 70 and impinges upon opacifying layer 72 causing ablation of the opacifying layer to remove a selected portion 90.

Laser beam 86 is preferably emitted from a scribe laser (not shown), which may be controlled to inscribe any desired pattern of ablated regions in opacifying layer 72. Accordingly, the scribe laser may be controlled so as to produce any desired diffractive microstructure 92 in opacifying layer 72.

Through the use of a scribe laser, an individual diffractive structure 92 may be formed in opacifying layer 72. In accordance with this embodiment of the invention, therefore, personalised security documents, such as identification cards, may be produced with alphanumeric and/or encrypted data, that are unique to a particular individual.

Again, a further protective layer 94 may be applied over the diffractive microstructure 92, filling the ablated regions, without destroying the diffractive properties of the structure.

FIG. 10 illustrates schematically, in cross-section, one embodiment of a completed security document made in accordance with the method of the invention. In producing the completed article, transparent substrate 70 preferably formed from biaxially oriented polypropylene (BOPP) is coated with opacifying layer 72, and diffractive microstructure 82, 92 ablated from the opacifying layer in accordance with an embodiment of the method of the invention as described with reference to FIG. 8 or FIG. 9.

Once the optically diffractive structure 82, 92 has been produced, further layers may be applied in order to complete the article. In the embodiment shown in FIG. 10, a further supporting layer 96 has been applied. Subsequently, an additional layer of a biaxially oriented polymeric material 98 has been applied, and further protective laminates 99 have been applied as an overlay on each side of the article.

Since the diffractive optical microstructure 82, 92 is formed prior to the application of further layers, the supporting layer 96 may be formed from stiffer materials that are more suitable for forming identity cards, credit cards or the like, but which are not transparent to the wavelength of laser light used to ablate the selected portions of the opacifying layer 72. For example, supporting layer 96 may be a polyethylene/polyester coextrusion, which is not transparent to light having a wavelength of 248 nm. It will, of course, be appreciated that all of the layers of the completed article must be transparent to visible light to enable the alphanumeric and/or encrypted data recorded in the diffractive micro-structure 82, 92 to be read by passing visible light through the ablated portions.

Referring to FIG. 11, there is shown an apparatus 100 for performing a method of direct laser scanning using an XY galvanometer according to an embodiment of the invention. As illustrated in FIG. 11, a security document or other article 102 includes a substrate 104, transparent at least to visible light, upon one surface of which is disposed a layer 106, which may be, for example, an opacifying layer consisting of or including a suitable pigment ink. For convenience, throughout this description target objects of this type (ie having a transparent substrate and a layer disposed upon at least one surface thereof) are described. It is to be understood that such target objects are exemplary only, and that the invention in its various forms may act upon targets having other structures. For example, methods according to embodiments of the invention may be used to directly ablate the surface of a substrate eg 104. Alternatively, a plurality of layers may be applied to the substrate 104, and methods according to various embodiments of the invention may be used to ablate internal layers, ie layers other than the surface layers, within the resulting structure. It will therefore be understood that references within this specification to layers applied to a substrate encompass layers applied directly to a surface of the substrate, or to additional layers subsequently applied, and include surface layers and internal layers of such laminated structures. Furthermore, the target object eg 102 may be a security document or similar article, or it may be a mask intended to be used in a laser writing process for production of a security document or article bearing a personalised diffractive optical microstructure.

The purpose of the apparatus 100 is to form a diffractive optical microstructure containing alphanumeric and/or encrypted data on the surface of the security document or other article 102 by ablating regions of the surface layer 106. The apparatus 100 includes a laser source 108, which includes a laser and other necessary optics for generating a suitable output laser beam 110 for the purposes of ablating the surface layer 106. As illustrated in FIG. 11, a mirror 112 is used to direct the laser beam 110 by XY galvanometer 114 and telecentric optics 116 onto the surface of the article 102. The function of the XY galvanometer 114 is to deflect the laser beam 110 under electronic control, while the telecentric optics 116 ensure that the deflected beam results in a corresponding undistorted spot on the surface layer 106 of the article 102. Accordingly, the telecentric scanning head arrangement 114, 116 may be used to direct the laser beam 110 to any desired position on the surface of the article 102 located generally beneath the scanning head.

According to presently preferred embodiments of the arrangement 100, the laser source 108 may include a frequency tripled or quadrupled Nd:YAG laser system, which when combined with a suitable telecentric scanning arrangement 114, 116 is capable of directing laser light onto the surface layer 106 of article 102 having a spot size of approximately 7 microns, which is sufficient for producing a diffractive optical microstructure by laser ablation of the surface layer 106.

FIG. 12 illustrates an alternative apparatus for performing direct laser scanning over the surface of an article 202 including a substrate 204 and surface layer 206, using a computer numerical control (CNC) stage 218. The apparatus 200 includes a laser source 208, which generates a laser beam output 210. As shown in FIG. 12, the output of laser source 208 is directly targeted onto the surface layer 206 of article 202. The article 202 is secured to CNC stage 218, which is operable under computer control to move along two orthogonal axes, as represented by the bidirectional arrows 220, 222 indicating movement along the X and Y cartesian coordinates respectively.

An advantage of the apparatus 200 based upon a CNC stage over the apparatus 100 based upon an XY galvanometer is that the laser source 208 may be a more readily available frequency doubled Nd:YAG laser. However, the CNC stage is slower in use, due to the requirement for mechanical movement of the article 202, as opposed to the purely optical beam movement facilitated by the XY galvanometer arrangement 100.

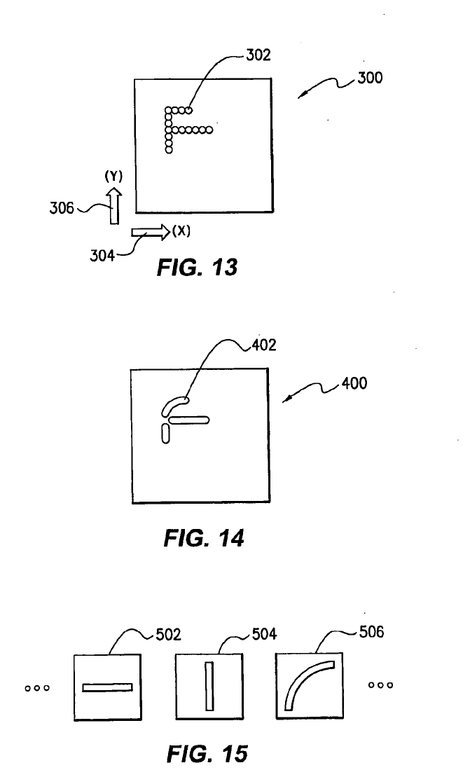

Either one of the arrangements 100, 200 may be used for pixel and/or vector marking of the surface layer 106, 206 of the articles 102, 202, as illustrated schematically in FIGS. 13 and 14. FIG. 13 shows an example of pixel marking of a substrate 300, whereas FIG. 14 illustrates an example of vector scanning of a substrate 400. In the process of pixel marking, the laser beam 110, 210 is directed towards a desired XY position on the substrate 300, as illustrated by the conventional cartesian axes 304, 306. Once the beam has been directed towards a location on the surface layer 106 which is to be ablated for the purposes of forming a diffractive optical microstructure, the laser source, 108, 208 may be fired in order to effect the ablation of the surface layer 106. Accordingly, the desired structure is formed on the surface layer 106, 206 by ablation of individual pixels, for example pixel 302 illustrated in FIG. 13.

An example of vector scanning of a substrate 400 is illustrated in FIG. 14. Vector scanning provides an alternative method of forming diffractive optical microstructures which has certain advantages over the pixel marking method. Whereas pixel marking involves defining the desired diffractive optical microstructure as a two dimensional field of predetermined dimensions, and sub-dividing the field into an array of discrete elements or pixels, vector scanning involves representing the desired diffractive optical microstructure as a plurality of narrow tracks. Each such track is sufficiently narrow to cause diffraction of laser light passing therethrough. It will be understood that the pixelation of a diffractive optical microstructure mask image is a product of the method by which it is calculated. However, it will be appreciated that diffraction is more generally the bending of light at a pin hole or a slit, and accordingly that a diffractive optical microstructure mask may be thought of as consisting of a series of narrow tracks which are generalisations of linear slits. The shape of the tracks will determine the pattern in which light passing therethrough is diffracted, and the width of the track will determine the angle of diffraction. Advantageously, masks consisting of tracks of 20 to 25 microns in width may be used to produce images having effective pixel sizes of 5 to 10 microns. Accordingly, vector scanning may be used to generate masks using lasers having a larger spot size of 20 to 25 microns to achieve a final effect that is equivalent to a 10 micron pixel size image.

For example, FIG. 14 illustrates the surface of a substrate 400 in which vector tracks eg 402, have been ablated. This may be achieved using the apparatus of either FIG. 11 or FIG. 12 by first directing the laser beam 110, 210 onto the point of the surface layer 106 at which the desired track commences, activating the laser 108, 208, and then scanning the location of the laser beam on the surface layer 106 using XY galvanometer 114 or CNC stage 218 in order to form the desired track, eg 402. The required tracks to be written may be determined by first generating the required personalised diffractive optical microstructure mask image, and then converting this mask image into a corresponding plurality of vectors. Image analysis techniques known in the art may be used to perform this conversion digitally based upon a bitmap image of the diffractive optical microstructure mask.

The vector scanning method illustrated by FIG. 14 is more suitable for producing a DOE with stored alphanumeric data, with the vector tracks representing letters and/or numerals, or parts thereof, of the stored data. Such alphanumeric data, eg the name and identification or account number of the document holder can be read out by viewing on a screen 8 located in the reconstruction plane where the interference effect created by the DOE is reconstructed as illustrated by FIG. 2 or alternatively by the apparatus of FIGS. 5 and 6.

The pixel marking method of FIG. 13 is particularly suited for producing a DOE with stored encrypted data, although it is possible the vector marking method may be used for producing encrypted data.

At least two possibilities exist for encrypting data stored in the microstructure of the diffractive optical element (DOE). The raw data to be stored in the DOE may be encrypted before the pixels (or vector markings) of the DOE are created. It is also possible for the data to be encrypted during the Fourier transform calculation for the DOE image creation. It is further possible for the encrypted data to be intertwined with pixels or vector markings which form visible images when the DOE is illuminated by a substantially collinated light source. This can provide extra security as an anti-counterfeiting feature because a counterfeiter may attempt to replicate the visible image produced by the DOE without being aware of, or able to reproduce, the encrypted data stored in the DOE.

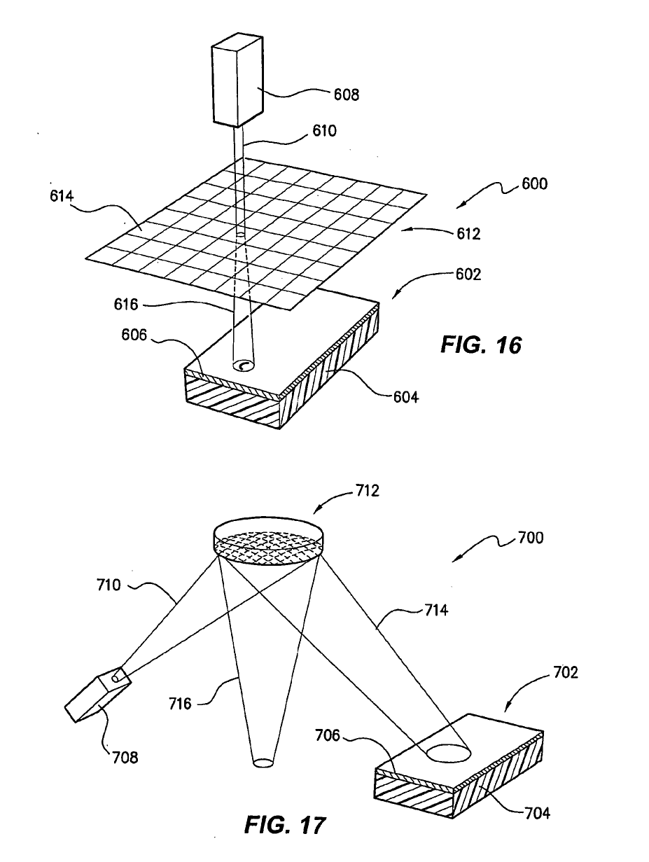

While the apparatus 100, 200 and corresponding methods, may be used to effectively form any desired alphanumeric and encrypted data in the diffractive optical microstructure in the surface layers 106, 206 of corresponding articles 102, 202, it is generally desirable to provide means and methods that may further accelerate the writing process. This is particularly so for producing alphanumeric and/or encrypted data for personalised documents or articles, because the overall rate of production of security documents for other articles will be limited by the rate at which the personalised data in the diffractive optical elements can be formed on the finished articles. Accordingly, FIGS. 15 and 16 illustrate a further embodiment of the present invention which may enable more rapid creation of a diffractive optical microstructures.

According to the further method illustrated by FIGS. 15 and 16, a mask pattern for a diffractive optical microstructure is divided into sub-regions, each of which corresponds with a group of pixels in an overall mask image. For example, each sub-region may represent a square or rectangular region of 10 to 20 by 10 to 20 pixels in dimensions. The corresponding portion of the mask image may then be approximated by one of a predetermined number of sub-masks, each of which defines a fixed graphical form, for example, a curve, a vertical line, a horizontal line, or a line at any other arbitrary angle. FIG. 15 illustrates three examples representative of such predetermined sub-masks, specifically horizontal line 502, vertical line 504, and curved line 506.

Once the overall desired microstructure has been broken down into the separate sub-regions, an apparatus such as the arrangement 600 may be used to ablate corresponding regions of the surface layer 606 of article 602 in accordance with the following description.

The apparatus 600 further includes a laser source 608 which generates a beam 610. A mask plate 612, which may be, for example, a quartz mask plate, consists of an array of predefined sub-masks, eg 614. The laser source 608, the mask plates 612, and/or the target article 602 are positionable under computer control such that the laser beam 610 may be fired through any one of the predetermined sub masks onto a desired sub-region of the surface layer 606, in order to perform ablation in accordance with the shape of the sub-mask. Accordingly, the desired diffractive optical microstructure may be constructed, in the manner of a jigsaw, using sub units selected from the predetermined set of masks, eg 614, that are much larger than a single pixel. This may considerably accelerate the process of creation of the diffractive optical microstructure. For example, if the microstructure image consists of around 4 to 16 million pixels, the total number of laser shots required may be reduced from this value to as few as 20,000, corresponding with a 100 second creation time at a firing rate of 200 Hz. Furthermore, this technique may be carried out using a diffractive mask and a wider choice of lasers, including excimer lasers, Nd:YAG lasers, CO₂ lasers and so forth.

FIG. 17 illustrates an apparatus 700 for performing a method of direct imaging using a micro-mirror array 712 according to yet another embodiment of the invention. In accordance with the arrangement 700, a laser source 708 generates a beam 710 which is directed onto micro mirror array 712. The laser 708 may be, for example, an excimer layer.

The array 712 includes a large number, and possibly millions, of small mirrors which are individually controllable such that the reflective surface may be directed at a desired angle relative to the laser source 708 and the target article 702.

In accordance with an embodiment of the invention, the mirrors of array 712 are controlled such that desired components of the beam 710 are directed to the surface layer 706 of the article 702 as a patterned beam of light 714. This patterned beam thereby ablates the surface layer 706 to form a desired diffractive optical microstructure thereon. The remaining mirrors are controlled so as to direct undesired portions of the incident beam 710 into beam 716, which is directed away from the target article 702.

It will be appreciated by those skilled in the art that the misdirected beam 716 bears a pattern which is the inverse of that borne by the beam 714, and that this beam, if directed onto a similar surface layer to that of the article 702 would therefore form an inverse diffractive optical microstructure having properties identical to those of the positive. Accordingly, an advantage of the apparatus 700 illustrated in FIG. 17 is that it could be used to simultaneously create two articles bearing corresponding personalised diffractive optical microstructures.

A further variation of the technique is exemplified by the apparatus 700 would use multiple, smaller beams each directed onto a simpler micro-mirror array in order to generate the desired diffractive optical microstructure pattern by interference between the beams reflected from the arrays.

As has previously been suggested, all of the foregoing methods and apparatus may be used either to directly ablate the surface of a security document or other article, or to ablate a surface layer of a substrate in order to produce a mask which could subsequently be used for creation of a diffractive optical microstructure containing alphanumeric or encrypted data in a finished article using conventional mask ablation techniques. Indeed, a particular advantage of this approach is that a mask may be generated prior to the security document or other article becoming available for surface ablation. This would enable other features of the finished security document or article to be formed simultaneously with the formation of a mask for the formation of a personalised diffractive optical microstructure. Such a technique of parallel manufacturing would further increase throughput of production of personalised security documents or other articles.

In addition, a mask could be manufactured to a somewhat larger scale than the desired diffractive optical microstructure image. For example, a four-times scale image would enable the mask to utilise 15 micron pixels or 30 micron tracks, and to be generated upon materials having a reduced cost such as aluminium coated polypropylene. The smaller finished diffractive optical microstructure would subsequently be formed using known magnifying optical arrangements, wherein the optical power density applied to the surface of the security document or article after passage through the imaging optics. This enables lasers having a larger spot size to be utilised, and materials having a lower tolerance to optical power to be used for the masks. The reduced incident power density may increase the durability and corresponding lifetime of the masks.

In addition to the foregoing techniques, a photolithography technique could be employed for manufacture of masks.

Following use of the mask in production of the security document or other article, the mask may either be discarded or stored in a library for future reissues or other reference uses.

According to further embodiments of the invention, masks and/or diffractive optical microstructures containing alphanumeric and/or encrypted data may be produced using suitable printing techniques. In practice, a suitable printing technique should be capable of providing a true resolution of around 5,000 dpi, in order to produce pixels having dimensions on the order of 5 microns. It should be appreciated that the specified resolution of many printers commonly used relates to the density of ink spots printed, and not to the size of the spots which may be somewhat larger then the claimed resolution. In some cases, therefore, a printer specified for a resolution of 5,000 dpi would not be suitable for the production of a diffractive optical microstructure mask. However, an inkjet, laser printing and/or digital printing system could be used so long as it was capable of producing sufficiently small ink or toner spots.

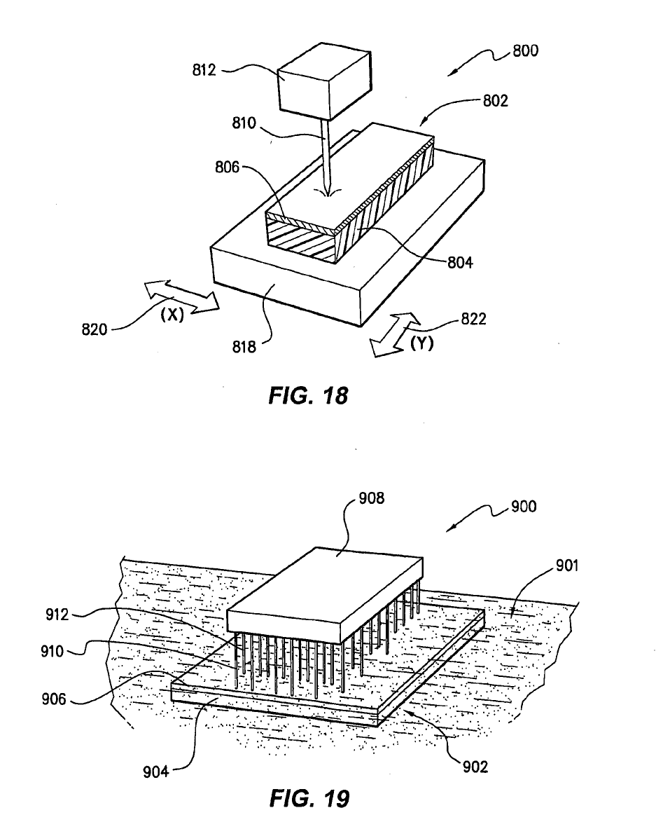

FIG. 18 illustrates an apparatus 800 for performing a method of direct CNC machining of a surface layer 806 of an article 802. The apparatus 800 includes a mechanical support 802 to which is a fixed and extensible needle 810. The article 802 is mounted on CNC stage 818, which may be translated along the two axes X and Y 820, 822. The needle 810 may be extended to mechanically ablate a corresponding spot on the surface layer 806 disposed on substrate 804 of the article 802. In a like manner to the optical apparatus 100, 200, the arrangement 800 may be used to ablate pixels and/or tracks in the surface layer 806 of the article 802.

FIG. 19 illustrates an apparatus 900 for performing a method of electro-chemical machining of a mask 902 consisting of a transparent substrate 904 and surface layer 906. The surface layer 906 is a metallic layer, and the substrate 904 may be quartz or a suitable polymer.

Electro-chemical machining involves the removal of metal using an electrical current in a suitable salt solution. In the arrangement 900, the mask 902 is immersed within a salt bath 901. A specialised electrode 908 includes a two dimensional array of retractable and/or extensible pins, eg 910, 912, which may be extended and/or retracted in a desired pattern of a contact with the metalisation layer 906.

By applying a current to the electrode 908, selected pixels may thereby be removed using the electro-chemical effect from the metalisation layer 906. This technique may therefore be used to create a desired mask for use in laser writing of the diffractive optical microstructure containing alphanumeric and/or encrypted data.

It will be appreciated from the foregoing description that the present invention encompasses various embodiments of methods and apparatus suitable for producing customised diffractive optical microstructures enabling the fabrication of individually a customised security documents or other articles. The invention encompasses techniques that are sufficiently practical, fast and cost effective to be used in the production of personalised security documents. Accordingly, the invention overcomes or mitigates problems of the prior art, whereby it was generally impractical to mass-produce diffractive optical microstructures that are required to be different on each security document or other article produced.

It will also be appreciated that at least some of the methods of production allow data to be added during the life of the document, for example by leaving at least some of the area of the DOE blank in the original DOE creation process. It is also possible to build in redundancy, if required, into the data stored in the DOE. Whilst many of the DOEs produced by the methods described above will be write once, read many structures, it may be possible to modify at least some of the data written into the DOE, eg by a laser writing process.

It will also be appreciated that various modifications and/or alterations that would be apparent to a person of skill in the art may be made without departing from the scope of the invention. For example, the apparatus and methods described herein may be combined in various ways for the production of masks and/or diffractive optical microstructures, and in this respect each specific embodiment should be considered to be exemplary only.

1-41. (canceled)

42. A diffractive optical element (DOE) comprising a diffractive microstructure which includes encrypted data stored within the microstructure of the DOE, wherein when the DOE is illuminated with substantially collimated light, the diffractive microstructure generates a far field interference pattern corresponding to the stored data that is reconstructed in a reconstruction plane remote from the DOE.

43. A security document or article which includes a diffractive optical element (DOE) in accordance with claim 42.

44. A security document or article according to claim 43 wherein the document is an identification document, and the encrypted data includes personalised data relating to the holder of the identification document.

45. A DOE, according to claim 42 wherein the encrypted data stored in the microstructure of the DOE is readable by apparatus including a detector located in the reconstruction plane and decryption means for decrypting the encrypted data.

46. A DOE, according to claim 45 wherein the DOE is also arranged to generate a projected visual image in the reconstruction plane when the DOE is illuminated with substantially collimated light.

47. A DOE, according to claim 46 wherein the projected visual image is generated by a first set of pixels or vector elements in the DOE and the encrypted data is stored in a second set of pixels or vector elements intertwined with the first set.

48. A method of storing and reading data in a document including the steps of:
providing a diffractive optical microstructure in the document wherein encrypted data is stored in the microstructure;
illuminating the diffractive optical microstructure with substantially collimated light whereby a far field interference pattern is generated corresponding to the encrypted data that is reconstructed in a reconstruction plane remote from the diffractive optical microstructure;
detecting the far field interference pattern in the reconstruction plane; and
decrypting the encrypted data detected in the reconstruction plane.

49. A method of storing and reading data according to claim 48 wherein the far field interference pattern is detected by detecting the light intensity of the interference pattern in the reconstruction plane.

50. A method according to claim 49 wherein encrypted data in the light intensity pattern is decrypted by a computer program which transforms the detected light intensity pattern into machine readable data.

51. Apparatus for reading encrypted data stored in a diffractive optical microstructure in a document wherein encrypted data is stored in the microstructure, the apparatus including:
means for directing a substantially collimated beam of light onto the diffractive optical microstructure such that the beam is transformed into a far field interference pattern corresponding to the stored encrypted data that is reconstructed in a reconstruction plane remote from the microstructure;
optical detection means located in the reconstruction plane for detecting the far field interference pattern and for generating signals representing the stored encrypted data; and
processing means for receiving and processing the signals from the optical detection means, wherein the processing means includes decryption means for decrypting the encrypted data represented by the signals from the detection means.

52. A method of producing a diffractive optical element (DOE) with encrypted data stored therein including the steps of:
providing a substrate which is transparent at least to visible light;
forming a diffractive optical microstructure on at least one side of the substrate or in a layer applied thereto;
whereas the diffractive optical microstructure is formed with encrypted data such that when the diffractive optical microstructure is illuminated with substantially collimated light a far field interference pattern representing the stored data is generated that is reconstructed in a reconstruction plane remote from the diffractive optical microstructure.

53. The method of claim 52 including the further steps of:
representing the diffractive optical microstructure as a two-dimensional field having predetermined dimensions;
subdividing the two-dimensional field into an array of discrete elements; and
determining the content of discrete elements of the field in order to form the encrypted data of the diffractive optical microstructure.

54. The method of claim 53 wherein each said discrete element is a pixel, whereby the data stored in the diffractive optical microstructure is a bitmap.

55. The method of claim 52 wherein the stored data is encrypted during a Fourier transform calculation for the creation of the diffractive optical microstructure.

56. The method of claim 52 further including the step of forming the diffractive optical microstructure such that when suitably illuminated a projected visual image is generated which is viewable in the reconstruction plane.

57. The method of claim 56 wherein the parts of the diffractive optical microstructure representing the encrypted data are intertwined with parts of the diffractive optical microstructure representing the visual image.

58. A diffractive optical element (DOE) comprising a diffractive microstructure which comprises a plurality of apertures formed in a substantially opaque layer disposed on a substrate which is transparent at least to visible light, wherein encrypted data is stored within the microstructure of the DOE, and wherein when the DOE is illuminated with substantially collimated light, the diffractive microstructure generates a far field interference pattern corresponding to the stored data that is reconstructed in a reconstruction plane remote from the DOE.

59. A method of producing a diffractive optical element (DOE) with encrypted data stored therein including the steps of:
providing a substrate which is transparent at least to visible light;
forming a diffractive optical microstructure comprising a plurality of apertures formed in a substantially opaque layer disposed on at least one side of the substrate;
whereas the diffractive optical microstructure is formed with encrypted data such that when the diffractive optical microstructure is illuminated with substantially collimated light a far field interference pattern representing the stored data is generated that is reconstructed in a reconstruction plane remote from the diffractive optical microstructure.

60. A method of storing and reading data in a document including the steps of:
providing a diffractive optical microstructure in the document, wherein the diffractive optical microstructure comprises a plurality of apertures formed in the document, or in a substantially opaque layer thereof; and wherein encrypted data is stored in the microstructure;
illuminating the diffractive optical microstructure with substantially collimated light whereby a far field interference pattern is generated corresponding to the encrypted data that is reconstructed in a reconstruction plane remote from the diffractive optical microstructure;
detecting the far field interference pattern in the reconstruction plane; and
decrypting the encrypted data detected in the reconstruction plane.

61. Apparatus for reading encrypted data stored in a diffractive optical microstructure in a document, wherein the diffractive optical microstructure comprises a plurality of apertures formed in the document or in a substantially opaque layer thereof, and wherein encrypted data is stored in the microstructure, the apparatus including:
means for directing a substantially collimated beam of light onto the diffractive optical microstructure such that the beam is transformed into a far field interference pattern corresponding to the stored encrypted data that is reconstructed in a reconstruction plane remote from the microstructure;
optical detection means located in the reconstruction plane for detecting the far field interference pattern and for generating signals representing the stored encrypted data; and
processing means for receiving and processing the signals from the optical detection means, wherein the processing means includes decryption means for decrypting the encrypted data represented by the signals from the detection means.
